(19) United States
(12) Patent Application Publication
(10) Pub. No.: US 2017/0186570 A1
(43) Pub. Date: Jun. 29, 2017

(54) BACKLIGHT KEYBOARD STRUCTURE

(71) Applicant: JIANGSU TRANSIMAGE TECHNOLOGY CO., LTD, Yangzhou City (CN)

(72) Inventor: Weimin Zou, Yangzhou City (CN)

(21) Appl. No.: 15/003,939

(22) Filed: Jan. 22, 2016

(30) Foreign Application Priority Data
Dec. 23, 2015 (CN) 2015109820706

(51) Int. Cl. H01H 13/83; H01H 13/02

(52) U.S. Cl. CPC H01H 13/83; H01H 13/023; H01H 2219/06; H01H 2219/062

(57) ABSTRACT

A backlight keyboard structure includes a keycap and a base plate. The keycap and the base plate are coupled via a pair of scissors, a conducting circuit board and an elastic body for supporting the keycap and transmitting a pressure of the keycap to the conducting circuit board to conduct a circuit are arranged between the keycap and the base plate. The backlight keyboard structure further includes a backlight module located between the conducting circuit board and the base plate. The pair of scissors can slide on both the base plate and the backlight module.

### TECHNICAL FIELD

The invention relates to a keyboard structure, and more particular to a backlight keyboard structure, belonging to the electronic technique field.

### BACKGROUND

A backlight keyboard is mainly reflected in that keyboard buttons or a panel gives out light, button letters can be clearly seen at night without turning a lamp on. In this way, it is quite convenient for people who deal with affairs at night and the appearance of the keyboard is extremely attractive. When a computer receives a key knocking-on instruction, the keyboard buttons are connected with an optical signal of a light emitting diode to light.

The backlight keyboard is mainly composed of a keyboard component and a backlight module. The traditional backlight module is generally adhered below the base plate of the keyboard, so that it is more tedious to assemble the backlight keyboard; moreover, the base plate is provided with a plurality of broken holes, so that rays of light from the backlight module are transmitted to the keyboard buttons. On one hand, the technique is complicated; on the other hand, the plurality of broken holes on the base plate will greatly reduce the strength of the keyboard.

### SUMMARY

### Invention Object

the object of the invention is to provide a backlight keyboard structure capable of conveniently and effectively utilizing light source.

### Technical Scheme

a backlight keyboard structure according to the invention includes a keycap and a base plate, wherein the keycap and the base plate are coupled via a pair of scissors, a conducting circuit board and an elastic body for supporting the keycap and transmitting a pressure of the keycap to the conducting circuit board to conduct a circuit are arranged between the keycap and the base plate, and the backlight keyboard structure further includes a backlight module located between the conducting circuit board and the base plate.

By arranging the backlight module above the base plate, the light source from the backlight module will directly reflect the rays of light to the keycap via the conducting circuit board or the hole on the conducting circuit board, without opening holes on the base plate. It is simpler and more direct to utilize the light source.

To be specific, the pair of scissors includes an upper scissor pin, a lower scissor pin and a central axle hole for fixing the elastic body, the base plate is provided with a lower snap, an upper snap is arranged at the bottom of the keycap, the upper scissor pin is coupled with the upper snap, the lower scissor pin passes through the backlight module to couple with the lower snap; when the keycap is pressed, the elastic body is therefore pressed, the lower scissor pin is pulled away from the lower snap via an elastic force and moves on the upper surface of the backlight module, any layer surface of the backlight module or the upper surface of the base plate.

The backlight module includes a FPC circuit board, a light emitting diode connecting with the FPC circuit board and a light guide plate transmitting the light from the light emitting diode to the light guide plate of the keycap.

Further, a reflecting sheet is arranged below the light guide plate, or reflective ink covers the lower surface of the light guide plate. Part of diffused light is gathered and recovered by the reflecting sheet or the reflective ink, which can further improve the brightness of the keyboard.

Further, a shading sheet can be arranged above the light guide plate, or shading ink covers the lower surface of the light guide plate. The light source is only reflected in the keycap through the shading sheet or the shading ink to centrally utilize the light source.

### Beneficial Effects

compared to the prior art, the invention has the advantages as follows: the backlight keyboard structure according to the invention arranges the backlight module above the base plate, so that rays of light are directly given out from the front of the backlight module, without opening a hole on the base plate, which, on one hand, more simply and more directly utilizes the light source, and on the other hand, enables the whole strength of the keyboard to be better; at the same time, the backlight module is arranged inside the keyboard, so as to keep a backlight keyboard and a non-backlight keyboard consistent in shape, which is more beneficial to assembling the system.

### BRIEF DESCRIPTION OF THE DRAWINGS

FIG. 1 is a schematic structural diagram of a backlight keyboard in the prior art, wherein the arrow direction represents the transmission direction of rays of light;

FIG. 2 is a schematic diagram of a backlight keyboard structure according to the invention, wherein the arrow direction represents the transmission direction of rays of light;

FIG. 3 is an assembly diagram of a backlight keyboard structure according to the invention;

FIG. 4a is a schematic diagram of a pair of scissors moving on the upper surface of a base plate when pressing a keycap;

FIG. 4b is a schematic diagram of a pair of scissors moving on the upper surface of a backlight module when pressing a keycap;

FIG. 5a is a schematic structural diagram of a backlight module according to the invention; and

FIG. 5b is another schematic structural diagram of a backlight module according to the invention.

### DETAILED DESCRIPTION OF THE PREFERRED EMBODIMENTS

The technical scheme of the invention is further described hereinafter with reference to the drawings.

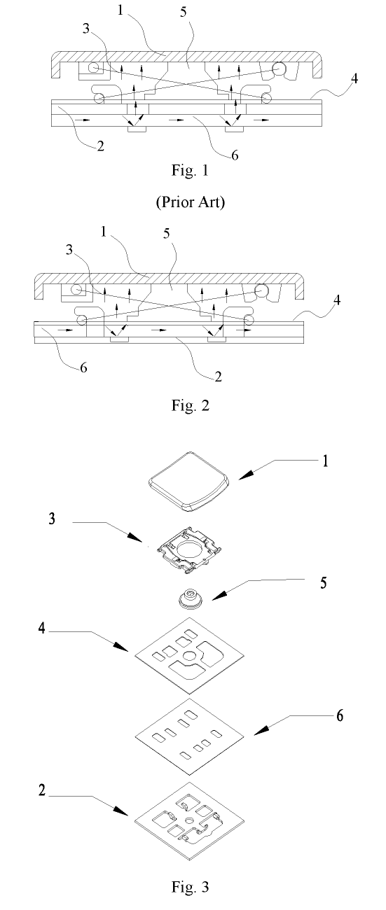

As shown in FIG. 1, the traditional backlight keyboard is generally composed of a keycap 1, a pair of scissors 3, an elastic body 5, a conducting circuit board 4, a base plate 2 and a backlight module 6 from top to bottom. The backlight module 6 is adhered below the base plate 2 of the keyboard, so that it is more tedious to assemble the backlight keyboard; moreover, the base plate 2 needs to be opened with a plurality of broken holes, so that the rays of light from the backlight module 6 are transmitted to the keycap 1. On one hand, the technique is complicated; on the other hand, the plurality of broken holes on the base plate will greatly reduce the strength of the keyboard.

As shown in FIG. 2 and FIG. 3, the backlight keyboard structure according to the invention includes a keycap 1 and a base plate 2, wherein a pair of scissors 3 is coupled between the keycap 1 and the base plate 2. An elastic body 5 and a conducting circuit board 4 are arranged between the keycap 1 and the base plate 2, and the elastic body 5 is used for supporting the keycap 1 and transmits a pressure of the keycap 1 to the conducting circuit board 4 to communicate the circuit. A backlight module 6 is arranged between the conducting circuit board 4 and the base plate 2.

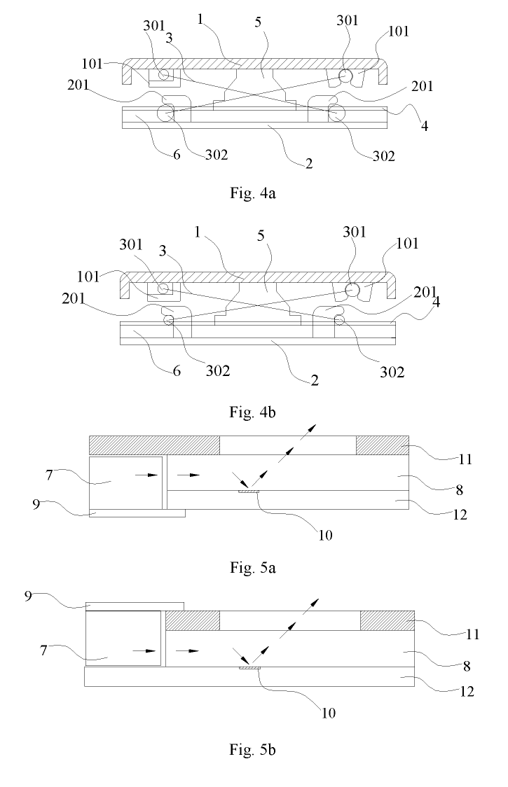

The base plate 2 can be provided with a low snap 201, the bottom of the keycap 1 is provided with an upper snap 101. The pair of scissors 3 includes an upper scissor pin 301, a lower scissor pin 302 and a central axle hole, as shown in FIG. 4a, the upper scissor pin 301 is coupled with the upper snap 101, and the lower scissor pin 302 passes through the backlight module 6 to couple with the lower snap 201; as shown in FIG. 3, before assembling, scissors 3 is a double-layer plate shape provided with a central axial bore; when assembling, the elastic body 5 passes through the centeral axial bore of the scissors 3, the upper scissor pin 301 and the lower scissor pin 302 are opened, and the elastic body 5 is fixed in the central axial bore of the scissors 3. When pressing the keycap 1, the elastic body 5 is pressed, thus the lower scissor pin 302 is driven to pull away from the snap on the upper surface of the base plate 2, and the lower scissor pin 302 slides on the upper surface of the base plate 2 left to right due to an elastic force; as shown in FIG. 4b, the pressed degrees of the elastic body 5 are different according to different pressing degrees, and the elastic forces generated thereof are unequal, so that the lower scissor pin 302 can also slide on the upper surface of the backlight module 6 or the surface of any layer of structure of the backlight module 6.

As shown in FIG. 5a and FIG. 5b, the backlight module includes a light emitting diode 7, a light guide plate 8 and a FPC circuit board 9, the light emitting diode 7 is connected with the FPC circuit board 9 to provide a light source, the rays of light given out from the light emitting diode 7 access to the light guide plate 8 and are transmitted to the keycap 1 via a light guide point 10 of the light guide plate 8. As shown in FIG. 5a, the FPC circuit board 9 can be located below the light emitting diode 7, and as shown in FIG. 5b, the FPC circuit board 9 can also be located above the light emitting diode 7.

A reflecting sheet 12 can be arranged below the light guide plate 8, or reflective ink covers the lower surface of the light guide plate 8. Part of diffused light is gathered by the reflecting sheet 12 or the reflective ink and reflected to the keycap to achieve the recycle of the light source, which can further improve the brightness of the keyboard.

A shading sheet 11 can be arranged above the light guide plate 8, or shading ink covers the lower surface of the light guide plate 8. The shading sheet 11 can be located below the conducting circuit board 4 or integrated at any layer inside the conducting circuit board 4. The rays of light reflected by the light guide plate 8 only penetrate through the keycap 1 by printing ink on the rest position of the surface of the shading sheet 11 except the corresponding keycap 1 to centrally utilize the light source, so that the lighting effect of the keyboard is more obvious. As part of rays of light transmitted by the light guide plate 8 is blocked by the shading sheet 11 to return to the light guide plate 8 and retransmitted to the keycap 1 via the light guide point 10 on the light guide plate 8 to achieve the recycle of the rays of light, the function of the reflecting sheet can be replaced by the part printed with ink of the shading sheet 11, thereby reducing the thickness of the keyboard.

According to the invention, the backlight module 6 is arranged above the base plate 2, the rays of light is directly given out from the front of the backlight module 6 and irradiated to the keycap 1 through the conducting circuit board 4 or the hole on the conducting circuit board 4 to enable the surface of the keyboard to give out light. Compared to the traditional backlight keyboard, it is simpler and more direct to utilize the light source, and the whole strength of the keyboard is better. At the same time, the shape of the backlight keyboard can be kept consistent with the shape of the non-backlight keyboard, which is more beneficial to assembling the system.

1. A backlight keyboard structure, comprising a keycap and a base plate, wherein the keycap and the base plate are coupled via a pair of scissors, a conducting circuit board and an elastic body for supporting the keycap and transmitting a pressure of the keycap to the conducting circuit board for switching a circuit are arranged between the keycap and the base plate, and the backlight keyboard structure further comprises a backlight module located between the conducting circuit board and the base plate, wherein the elastic body is devoid of an elastic plate and terminates at a lower circular peripheral edge in contact with the conducting circuit board, wherein the lower circular peripheral edge is spaced from a periphery of the conducting circuit board and the elastic body is not extending upwardly from any elastic plate, which provides an exposed upper surface of the conducting circuit board in all areas of an upper surface of the conducting circuit board other than an area covered by the elastic body, wherein light is directly given out from an upper surface of the backlight module and irradiated to the keycap through the conducting circuit board or through a hole in the conducting circuit board between the upper surface of the backlight module and the keycap, the light further travelling around the lower circular peripheral edge of the elastic body directly above the exposed upper surface of the conducting circuit board, wherein the exposed upper surface of the conducting circuit board is not covered by the elastic body.

2. The backlight keyboard structure according to claim 1, wherein the pair of scissors comprises an upper scissor pin, a lower scissor pin and a central axle hole for fixing the elastic body, the keycap has a bottom, the base plate is provided with a lower snap, an upper snap is arranged at a bottom of the keycap, the upper scissor pin is coupled with the upper snap, the lower scissor pin passes through the backlight module to couple with the lower snap; the elastic body is pressed when pressing the keycap, the lower scissor pin is pulled away from the lower snap via an elastic force and moves on an upper surface of the backlight module or an upper surface of the base plate.

3. The backlight keyboard structure according to claim 1, wherein the backlight module comprises a FPC circuit board, a light emitting diode connecting with the FPC circuit board and a light guide plate transmitting the light from the light emitting diode to the keycap, the light guide plate has a lower surface.

4. The backlight keyboard according to claim 3, wherein a reflecting sheet is arranged below the light guide plate, or reflective ink covers the lower surface of the light guide plate.

5. The backlight keyboard according to claim 4, wherein a shading sheet is arranged above the light guide plate, or shading ink covers the lower surface of the light guide plate.

6. The back light keyboard according to claim 3, wherein a shading sheet is arranged above the light guide plate, or shading ink covers the lower surface of the light guide plate.
